(19) United States
(12) Patent Application Publication
(10) Pub. No.: US 2025/0030378 A1
(43) Pub. Date: Jan. 23, 2025

(54) PHOTOVOLTAIC SUPPORT SPINDLE AND PHOTOVOLTAIC TRACKING SUPPORT

(71) Applicant: Arctech Solar Holding Co. LTD, Kunshan, Suzhou, Jiangsu (CN)

(72) Inventors: Ying Yang, Kunshan, Suzhou, Jiangsu (CN); Jingqiang Chen, Kunshan, Suzhou, Jiangsu (CN)

(73) Assignee: Arctech Solar Holding Co. LTD, Kunshan, Suzhou, Jiangsu (CN)

(21) Appl. No.: 18/550,022

(22) PCT Filed: Feb. 24, 2023
(86) PCT No.: PCT/CN2023/078037

§ 371 Date: Sep. 11, 2023

(30) Foreign Application Priority Data
May 31, 2022 (CN) 202221342724.0

(51) Int. Cl. H02S 20/32

(52) U.S. Cl. CPC H02S 20/32

(57) ABSTRACT

A photovoltaic support spindle, including at least a long shaft, where the long shaft includes a first flat panel, a second flat panel, a third flat panel, a first arc panel, a second arc panel, and a third arc panel; the first arc panel is connected between the second flat panel and the third flat panel; the second arc panel is connected between the first flat panel and the second flat panel; and the third arc panel is connected between the first flat panel and the third flat panel. The first arc panel, the second arc panel and the third arc panel are three arc surfaces distributed on a same cylindrical surface. The disclosure saves a material, reduces a cost and improves a bending resistance.

### TECHNICAL FIELD

The disclosure relates to the field of solar supports, and in particular to a photovoltaic support spindle and a photovoltaic tracking support.

### BACKGROUND

At present, most torque tubes of photovoltaic tracking supports, namely photovoltaic support spindles, are circular tubes or square tubes. In spite of a better bending resistance than the circular tubes, the square tubes are poor in torsion resistance. Although with a better torsion resistance than the square tubes, the circular tube has arc-shaped surface, which is not conductive to providing purlins with planes. Photovoltaic tracking support manufacturers are devoted to designing a torque tube with the bending resistance, torsion resistance and cost effectiveness. There has been a D-shaped torque tube that achieves the torsion resistance and bending resistance, and provides a planar area (non-circular surface). However, the planar area still cannot facilitate location of a purlin desirably, thus affecting mechanical performance of the purlin. Moreover, the D-shaped torque tube is not cost-effective, and is hard for automatic machining.

Therefore, it is necessary to provide a novel photovoltaic support spindle and a novel photovoltaic tracking support to solve the above problems.

### SUMMARY

An objective of the disclosure is to provide a photovoltaic support spindle and a photovoltaic tracking support, to save a material, lower a cost, increase a planar area, and improve mechanical performance of a purlin.

To achieve the above objective, the disclosure provides a first technical solution: A photovoltaic support spindle includes at least a long shaft, where the long shaft includes a first flat panel, a second flat panel, a third flat panel, a first arc panel, a second arc panel, and a third arc panel; the first arc panel is connected between the second flat panel and the third flat panel; the second arc panel is connected between the first flat panel and the second flat panel; the third arc panel is connected between the first flat panel and the third flat panel; and the first arc panel, the second arc panel and the third arc panel are three arc surfaces distributed on a same cylindrical surface.

As a further improvement to the first technical solution of the disclosure, an arc length of the first arc panel is greater than an arc length of the second arc panel, and greater than an arc length of the third arc panel.

As a further improvement to the first technical solution of the disclosure, the arc length of the second arc panel is the same as the arc length of the third arc panel, and the second arc panel and the third arc panel are symmetric with respect to a perpendicular bisector of the first flat panel.

As a further improvement to the first technical solution of the disclosure, the first arc panel includes one end connected to the second flat panel and the other end connected to the third flat panel, thereby forming a U-shaped groove; and the second flat panel and the third flat panel are parallel to each other and have a same size.

As a further improvement to the first technical solution of the disclosure, the first flat panel includes one end connected to the second arc panel and the other end connected to the third arc panel, thereby forming a cap on the groove; the cap has an inverted bowl-shaped cross section; and the first flat panel serves as a bowl bottom of the cap.

As a further improvement to the first technical solution of the disclosure, the first flat panel extends in a first direction, the second flat panel and the third flat panel are parallel to each other and extend in a second direction perpendicular to the first direction; and the first flat panel, the second flat panel and the third flat panel have a same size.

As a further improvement to the first technical solution of the disclosure, the long shaft has a center of rotation; and the first arc panel, the second arc panel and the third arc panel each serve as one part of a circle that takes the center of rotation as a center and R as a radius.

As a further improvement to the first technical solution of the disclosure, there are two long shafts; the photovoltaic support spindle further includes a hoop sleeved on two adjacent ends of the two long shafts to connect the two long shafts; and an inner surface of the hoop is matched with an outer surface of each of the long shafts.

To achieve the above objective, the disclosure provides a second technical solution: A photovoltaic tracking support includes a photovoltaic support spindle, a post, and a support seat, where the photovoltaic support spindle includes three flat panels and three arc panels; the flat panels are provided alternately with the arc panels to form the photovoltaic support spindle; the photovoltaic support spindle has a multi-corner cross section with three concentric arcs; the support seat is connected to the post; the photovoltaic support spindle is inserted into the support seat; and an inner surface of the support seat is matched with an outer surface of the photovoltaic support spindle.

As a further improvement to the second technical solution of the disclosure, the photovoltaic tracking support further includes a photovoltaic panel and a connecting assembly, where one arc panel is connected between two opposite flat panels of the three flat panels to form a U-shaped groove; the connecting assembly includes a purlin and a connecting hoop; the purlin supports the photovoltaic panel and includes a flat bottom; the connecting hoop is U-shaped, with two ends connected to the flat bottom of the purlin; the purlin and the connecting hoop jointly form an accommodating cavity for allowing the photovoltaic support spindle to pass through; the connecting hoop is matched with the groove; and the flat bottom of the purlin is matched with the remaining flat panel of the three flat panels.

The present disclosure has the following advantages over the prior art:
(1) According to the photovoltaic support spindle in the photovoltaic tracking support provided by the disclosure, the upper first flat panel, the left second flat panel and the right third flat panel are designed as a plane. There are three arc panels connected between two adjacent ones of the flat panels. The three arc panels are three arc surfaces distributed on a same cylinder. The three flat panels facilitate installation of other components. Six corners are formed between the three flat panels and the three arc panels. Compared with a square tube and a circular tube, the photovoltaic support spindle has desirable torsion resistance and bending resistance.
(2) The left and right planes, namely the second flat panel and the third flat panel, can better locating a purlin. A transverse torsion on the purlin is shared by the second flat panel and the third flat panel, thereby improving the torsion resistance of the purlin. In addition, the second flat panel and the third flat panel also make automatic machining of the photovoltaic support spindle easier. The machined photovoltaic support spindle has a desirable straightness.
(3) Compared with a D-shaped torque tube, the second flat panel and the third flat panel can also save a material and reduce a cost.
(4) When the photovoltaic support spindle is connected to a rotary reducer, the multiple corners also facilitate transmission of a torque, thereby reducing requirements on a shearing force of a connecting bolt.

### BRIEF DESCRIPTION OF THE DRAWINGS

FIG. 1 is a schematic perspective view of a photovoltaic support spindle according to the disclosure;

FIG. 2 is an enlarged view of A in FIG. 1;

FIG. 3 is a front view of FIG. 1;

FIG. 4 is a schematic exploded view for the front view of FIG. 3 for ease of description;

FIG. 5 is an enlarged view of B in FIG. 4;

FIG. 6 is a schematic perspective view illustrating that two long shafts are connected through a hoop to form a photovoltaic support spindle of the disclosure;

FIG. 7 is a perspective exploded view of FIG. 6;

FIG. 8 is a schematic perspective view of a photovoltaic tracking support according to the disclosure;

FIG. 9 is an enlarged view of C in FIG. 8; and

FIG. 10 is an enlarged view of D in FIG. 8.

### DETAILED DESCRIPTION OF THE EMBODIMENTS

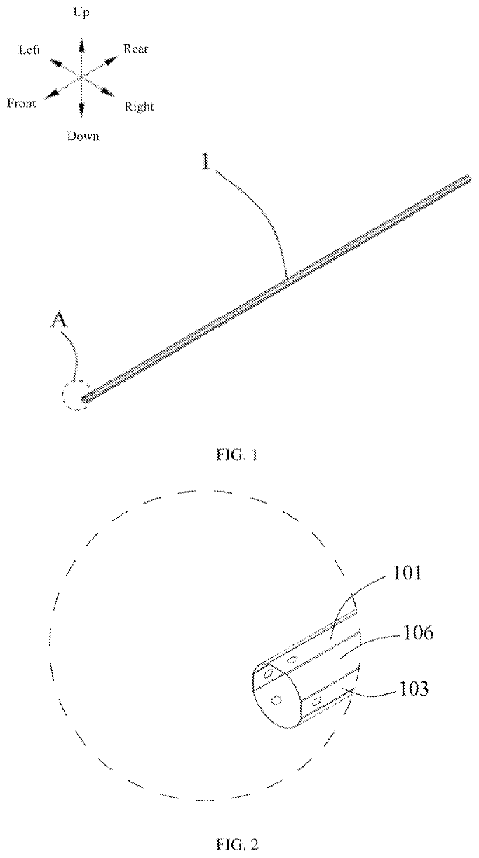

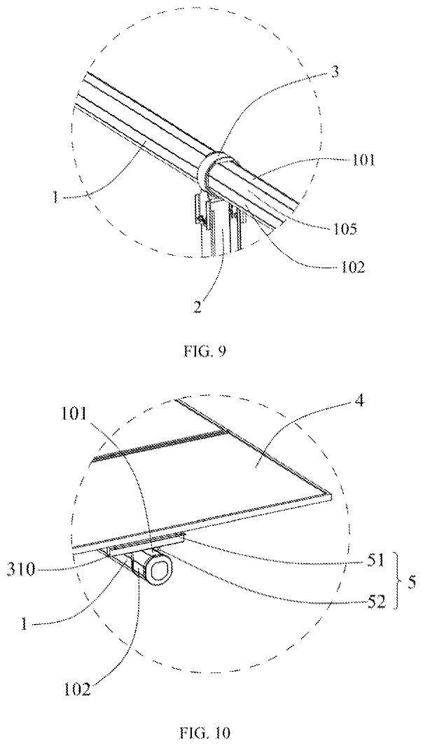

Referring to FIG. 1 to FIG. 10, the disclosure relates to photovoltaic support spindle 1 of a photovoltaic tracking support, including at least long shaft 10. In the implementation shown in FIG. 1, the photovoltaic support spindle 1 is the whole long shaft 10 extending in a front-rear direction and having a considerable length, namely there is one long shaft 10.

Referring to FIG. 2, the long shaft 10 includes upper first flat panel 101, left second flat panel 102, right third flat panel 103, first arc panel 104 connected between the second flat panel 102 and the third flat panel 103, second arc panel 105 connected between the first flat panel 101 and the second flat panel 102, and third arc panel 106 connected between the first flat panel 101 and the third flat panel 103. Particularly, the first arc panel 104, the second arc panel 105 and the third arc panel 106 are three arc surfaces distributed on a same cylindrical surface. In other words, three arcs defined by the first arc panel 104, the second arc panel 105 and the third arc panel 106 are concentric. The three flat surfaces facilitate installation of other components. Six corners are formed between the three flat surfaces and the three arc panels. Hence, desirable torsion resistance and bending resistance are achieved. In connection with a slew drive, the multiple corners also facilitate transmission of a torque, thereby reducing shearing force of a connecting bolt. Two opposite flat surfaces at left and right sides, namely the second flat panel 102 and the third flat panel 103, can better locating a purlin. A transverse torsion on the purlin is shared by the second flat panel 102 and the third flat panel 103, thereby improving the torsion resistance of the purlin. In addition, the second flat panel 102 and the third flat panel 103 also make automatic machining of the photovoltaic support spindle easier. The machined photovoltaic support spindle 1 has a desirable straightness. Compared with a D-shaped torque tube, the second flat panel 102 and the third flat panel 103 can also save a material and reduce a cost.

It is to be noted that an arc length of the first arc panel 104 is greater than an arc length of the second arc panel 105, and greater than an arc length of the third arc panel 106. Particularly, in the implementation, the photovoltaic support spindle 1 is an axisymmetric pattern in a left-right direction. In other words, the second arc panel 105 and the third arc panel 106 are symmetric with respect to a perpendicular bisector of the first flat panel 101. Therefore, the arc length of the second arc panel 105 is the same as the arc length of the third arc panel 106. For example, the arc length of the first arc panel 104 is twice the arc length of the second arc panel 105/the arc length of the third arc panel 106.

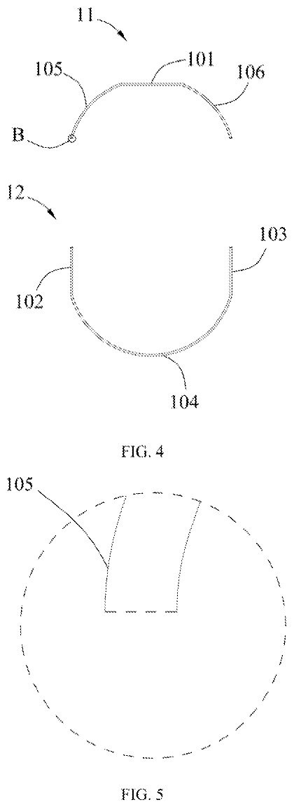

Referring to FIG. 1 to FIG. 5, the first arc panel 104 includes one end connected to the second flat panel 102 and the other end connected to the third flat panel 103, thereby forming U-shaped groove 12. The second flat panel 102 and the third flat panel 103 are parallel to each other and have a same size. The first flat panel 101 includes one end connected to the second arc panel 105 and the other end connected to the third arc panel 106, thereby forming cap 11 on the groove 12. The cap 11 has an inverted bowl-shaped cross section. The first flat panel 101 serves as a bowl bottom of the cap 11. Certainly, it is to be noted that the long shaft 10 of the actual product is integrally formed as shown in FIG. 1 to FIG. 3. FIG. 4 and FIG. 5 are only for the convenience of illustrating the shape of the circular cross-section of the support spindle 1, which is also the long shaft 10, of the photovoltaic support. In FIG. 5, a dotted line at an end of the second arc panel 105 indicate that the end of the second arc panel 105 and the end of the second flat panel 102 thereunder are not separated actually, but are connected integrally together. Correspondingly, a dotted line at an end of the third arc panel 106 indicates that the end of the second arc panel 105 and the end of the third flat panel 103 thereunder are not separated actually, but are connected integrally together.

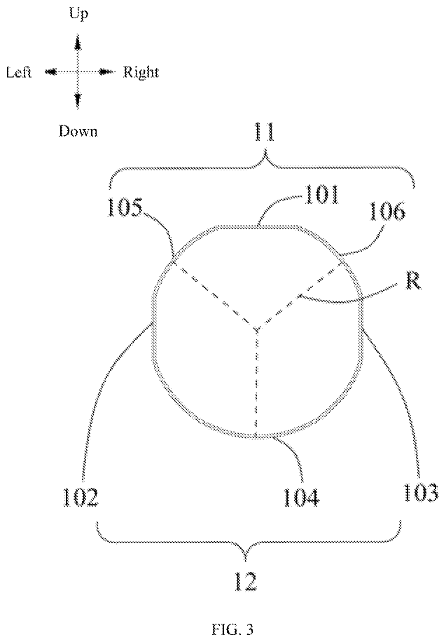

Referring to FIG. 3 and FIG. 4, it can be seen that the first flat panel 101 extends in the left-right direction, namely a first direction. The second flat panel 102 and the third flat panel 103 are parallel to each other and extend in an up-down direction, namely a second direction. Particularly, the first flat panel 101, the second flat panel 102 and the third flat panel 103 may have a same size.

Therefore, the long shaft 10 has a multi-corner cross section with six corners. Specifically, referring to FIG. 3, there are a first corner at a junction between the first flat panel 101 and the second arc panel 105, a second corner at a junction between the second arc panel 105 and the second flat panel 102, a third corner at a junction between the second flat panel 102 and the first arc panel 104, a fourth corner at a junction between the first arc panel 104 and the third flat panel 103, a fifth corner at a junction between the third flat panel 103 and the third arc panel 106, and a sixth corner at a junction between the third arc panel 106 and the first flat panel 101.

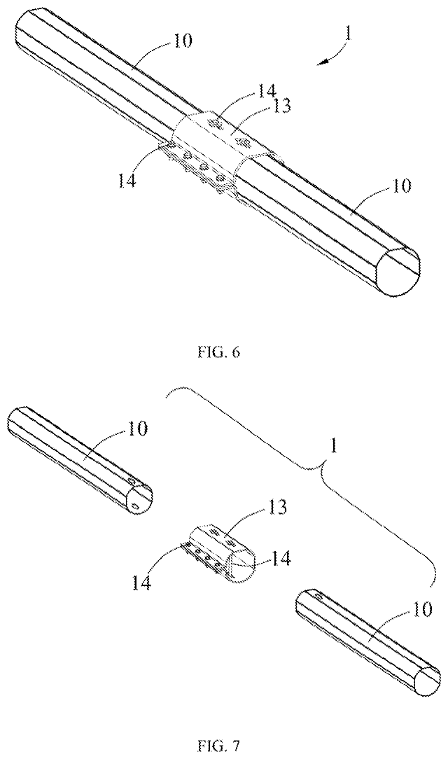

In other implementations shown in FIG. 6 and FIG. 7, the photovoltaic support spindle 1 may also be connected by two long shafts 10 with a shorter length. In other implementations, the photovoltaic support spindle further includes hoop 13 sleeved on two adjacent ends of the two long shafts 10 to connect the two long shafts 10. An inner surface of the hoop 13 is matched with an outer surface of each of the long shafts 10. A side of the hoop 13 is provided two sheets stacked up and down. The two sheets stacked up and down are fixed by bolts 14 after clasping the two adjacent ends of the long shafts 10. In addition, the hoop 13 may also be fixed with the two adjacent ends of the long shafts 10 by other bolts 14.

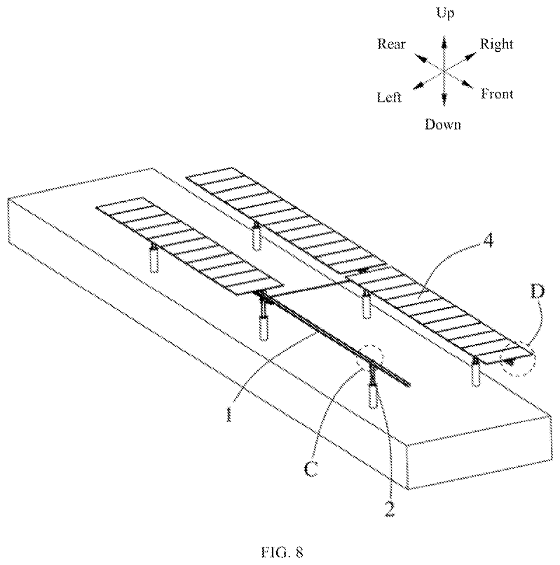

Referring to FIG. 8 to FIG. 10, the disclosure further relates to a photovoltaic tracking support, including photovoltaic support spindle 1, post 2, support seat 3, photovoltaic panel 4, and connecting assembly 5. The photovoltaic tracking support is a flat single-spindle photovoltaic tracking support or a linked photovoltaic tracking support.

Referring to FIG. 1 to FIG. 10 and focusing on FIG. 8 to FIG. 10, the photovoltaic support spindle 1 includes three flat panels and three arc panels. The three flat panels include the first flat panel 101, the second flat panel 102, and the third flat panel 103. The three arc panels include the first arc panel 104, the second arc panel 105, and the third arc panel 106. The flat panels are provided alternately with the arc panels to form the photovoltaic support spindle 1, such that the photovoltaic support spindle 1 has a multi-corner cross section with three concentric arcs. The support seat 3 is connected to the post 2. The photovoltaic support spindle 1 is inserted into the support seat 3. An inner surface of the support seat 3 is matched with an outer surface of the photovoltaic support spindle 1. One arc panel, namely the first arc panel 104, is connected between two opposite flat panels, namely the second flat panel 102 and the third flat panel 103, thereby forming a U-shaped groove 12. The connecting assembly 5 includes purlin 51 and connecting hoop 52. The purlin 51 supports the photovoltaic panel 4 and includes a flat bottom 510. The connecting hoop 52 is U-shaped, with two ends connected to the flat bottom 510 of the purlin 51. The purlin 51 and the connecting hoop 52 jointly form an accommodating cavity for allowing the photovoltaic support spindle 1 to pass through. The connecting hoop 52 is matched with the groove 12. The flat bottom 510 of the purlin 51 is matched with the remaining first flat panel 101 of the three flat panels.

The support spindle 1 has a center of rotation. When the support spindle 1 is provided on the post 2 through the support seat 3, a slew drive mechanism can drive the support spindle 1 to rotate around the center of rotation, thereby adjusting an angle of the photovoltaic panel 4 fixed on the support spindle 1 through the connecting assembly 5. Referring to FIG. 3, the first arc panel 104, the second arc panel 105 and the third arc panel 106 each serve as one part of a circle that takes the center of rotation as a center and R as a radius.

According to the photovoltaic support spindle 1 in the photovoltaic tracking support provided by the disclosure, the upper first flat panel 101, the left second flat panel 102 and the right third flat panel 103 are designed as a plane. There are three arc panels connected between two adjacent ones of the flat panels. The three arc panels 104, 105, 106 are three arc surfaces distributed on a same cylinder. The three flat panels 101, 102, 103 facilitate installation of other components. Six corners are formed between the three flat panels 101, 102, 103 and the three arc panels 104, 105, 106. Compared with a square tube and a circular tube, the photovoltaic support spindle has desirable torsion resistance and bending resistance. The left and right planes, namely the second flat panel 102 and the third flat panel 103, can better locating a purlin. A transverse torsion on the purlin is shared by the second flat panel 102 and the third flat panel 103, thereby improving the torsion resistance of the purlin. In addition, the second flat panel 102 and the third flat panel 103 also make automatic machining of the photovoltaic support spindle easier. The machined photovoltaic support spindle 1 has a desirable straightness. Compared with a D-shaped torque tube, the second flat panel 102 and the third flat panel 103 can also save a material and reduce a cost. When the photovoltaic support spindle 1 is connected to a slew drive, the multiple corners also facilitate transmission of a torque, thereby reducing requirements on a shearing force of a connecting bolt.

The above embodiments are merely intended to describe the disclosure, rather than limit the technical solutions of the disclosure. Descriptions on orientations such as “front”, “rear”, “left”, “right”, “upper” and “lower” should be understandable to those skilled in the art. Although the disclosure has been described in detail with reference to the above embodiments, those of ordinary skill in the art should understand that modifications or equivalent replacements can still be made by those skilled in the art to the disclosure. All technical solutions and improvements without departing from the spirit and scope of the disclosure should fall within the scope of the appended claims of the disclosure.

What is claimed is:

1. A photovoltaic support spindle (1), comprising at least a long shaft (10), wherein the long shaft (10) comprises a first flat panel (101), a second flat panel (102), a third flat panel (103), a first arc panel (104), a second arc panel (105), and a third arc panel (106); the first arc panel (104) is connected between the second flat panel (102) and the third flat panel (103); the second arc panel (105) is connected between the first flat panel (101) and the second flat panel (102); the third arc panel (106) is connected between the first flat panel (101) and the third flat panel (103); and the first arc panel (104), the second arc panel (105) and the third arc panel (106) are three arc surfaces distributed on a same cylindrical surface.

2. The photovoltaic support spindle (1) according to claim 1, wherein an arc length of the first arc panel (104) is greater than an arc length of the second arc panel (105), and greater than an arc length of the third arc panel (106).

3. The photovoltaic support spindle (1) according to claim 2, wherein the arc length of the second arc panel (105) is the same as the arc length of the third arc panel (106), and the second arc panel (105) and the third arc panel (106) are symmetric with respect to a perpendicular bisector of the first flat panel (101).

4. The photovoltaic support spindle (1) according to claim 1, wherein the first arc panel (104) comprises one end connected to the second flat panel (102) and the other end connected to the third flat panel (103), thereby forming a U-shaped groove (12); and the second flat panel (102) and the third flat panel (103) are parallel to each other and have a same size.

5. The photovoltaic support spindle (1) according to claim 4, wherein the first flat panel (101) comprises one end connected to the second arc panel (105) and the other end connected to the third arc panel (106), thereby forming a cap (11) on the groove (12); the cap (11) has an inverted bowl-shaped cross section; and the first flat panel (101) serves as a bowl bottom of the cap (11).

6. The photovoltaic support spindle (1) according to claim 1, wherein the first flat panel (101) extends in a first direction, and the second flat panel (102) and the third flat panel (103) are parallel to each other and extend in a second direction perpendicular to the first direction.

7. The photovoltaic support spindle (1) according to claim 1, wherein the long shaft (10) has a center of rotation; and the first arc panel (104), the second arc panel (105) and the third arc panel (106) each serve as one part of a circle that takes the center of rotation as a center and R as a radius.

8. The photovoltaic support spindle (1) according to claim 1, wherein there are two long shafts (10); the photovoltaic support spindle (1) further comprises a hoop (13) sleeved on two adjacent ends of the two long shafts (10) to connect the two long shafts (10); and an inner surface of the hoop (13) is matched with an outer surface of each of the long shaft (10).

9. A photovoltaic tracking support, comprising a photovoltaic support spindle (1), a post (2), and a support seat (3), wherein the photovoltaic support spindle (1) comprises three flat panels (101, 102, 103) and three arc panels (104, 105, 106); the three flat panels are provided alternately with the three arc panels to form the photovoltaic support spindle (1); the photovoltaic support spindle (1) has a multi-corner cross section with three concentric arcs; the support seat (3) is connected to the post (2); the photovoltaic support spindle (1) is inserted into the support seat (3); and an inner surface of the support seat (3) is matched with an outer surface of the photovoltaic support spindle (1).

10. The photovoltaic tracking support according to claim 9, further comprising a photovoltaic panel (4) and a connecting assembly (5), wherein one arc panel (104) is connected between two opposite flat panels (102, 103) of the three flat panels to form a U-shaped groove (12); the connecting assembly (5) comprises a purlin (51) and a connecting hoop (52); the purlin (51) supports the photovoltaic panel (4) and comprises a flat bottom (510); the connecting hoop (52) is U-shaped, with two ends connected to the flat bottom (510) of the purlin (51); the purlin (51) and the connecting hoop (52) jointly form an accommodating cavity for allowing the photovoltaic support spindle (1) to pass through; the connecting hoop (52) is matched with the groove (12); and the flat bottom (510) of the purlin (51) is matched with the remaining flat panel (101) of the three flat panels.
